(19) United States
(12) Patent Application Publication
(10) Pub. No.: US 2014/0299541 A1
(43) Pub. Date: Oct. 9, 2014

(54) WATER FILTRATION AND SEWAGE SYSTEM

(71) Applicant: John Armour, Jackonsville, FL (US)

(72) Inventor: John Armour, Jackonsville, FL (US)

(21) Appl. No.: 14/212,877

(22) Filed: Mar. 14, 2014

Related U.S. Application Data
(60) Provisional application No. 61/788,055, filed on Mar. 15, 2013.

(51) Int. Cl. C02F 1/44; C02F 3/00

(52) U.S. Cl. CPC C02F 1/44; C02F 3/00
USPC 210/631; 210/195.2; 210/137

(57) ABSTRACT

A system to reuse water from a septic/bio digester is shown. A sterile potable water stream is produced which is useful for humans, animals and fish farming.

### CROSS-REFERENCE TO RELATED APPLICATIONS

This application claims benefit of the priority of U.S. Provisional Application Ser. No. 61/788,055, filed on Mar. 15, 2013, and is a continuation-in-part of U.S. Ser. No. 13/667,712, filed on Nov. 2, 2012, which is a divisional application of U.S. Ser. No. 13/096,738, filed on Apr. 28, 2011, now U.S. Pat. No. 8,318,021, which issued on Nov. 17, 2012, which is a continuation of U.S. Ser. No. 12/317,929, filed on Dec. 30, 2008, and now abandoned, which is a continuation of U.S. Ser. No. 11/772,051, filed on Jun. 29, 2007 and now abandoned, which claims benefit of the priority date of U.S. Provisional Application Ser. No. 60/817,743, filed on Jun. 30, 2006; the contents which are each incorporated by reference herein in their entirety.

### FIELD OF THE INVENTION

This invention relates to a system to reuse water from a septic/bio digester. More particularly, this invention relates to a device and method for its use containing plural diverse treatment modalities working in concert to minimize fresh water consumption, provide clean water and energy, and allow for production of energy, fertilizer and foodstuffs.

### SUMMARY OF THE INVENTION

Sewage treatment systems use a great volume of water, most of which cannot be used for drinking water, given that this effluent is unsafe because of the bacterial and viral content therein. Many sewage treatment systems either use chemicals to make the water usable as a secondary source, or they dilute the effluent to a level that would be safe to dump.

The present invention is directed toward a method to reuse water from a septic or bio digester which involves the removal of all dangerous bacteria, viruses, proteins, and other organic material (including the digesting bacteria) from the water to produce a treated water stream, followed by return of the treated water stream to the septic system for continued digestion, whereby sterile water suitable for drinking water is produced.

In an embodiment, the invention teaches a portable system that can be used in a developing community to digest liquid human or animal waste, and reuse the water in a sterile state. Depending on the bacteria used to process the waste, small amounts of nitrogen and phosphorus that would remain in the drinking water can then be used in a greenhouse, to support the food need of the community. Water that has passed the greenhouse would then be filtered again to remove any bacteria from the plant media, and the energy that would be needed to power the pumps would come from solar, or bio gas produced in the septic system.

In an embodiment, it is contemplated to use a most similar method for processing waste water in fish farms, so that the fish can have clean sterile fresh water, while also removing metals and contaminants from the water, (like mercury, fluoride, etc.), thereby enhancing the health and growth of the fish.

In an alternative embodiment, it is further contemplated to use a similar method for processing wastewater from animals, so that the runoff from animal pens or confinement can be processed to avoid contamination of land, ground water, rivers, and streams.

### BRIEF DESCRIPTION OF THE FIGURES

FIG. 1 illustrates a system for water reuse from a septic/bio digester.

FIG. 2 illustrates a system for water reuse from a septic/bio digester housed in a container.

FIG. 3 is an internal diagram of a capillary system-based filter for use in the present invention.

### DETAILED DESCRIPTION OF THE INVENTION

The present invention is more particularly directed to a wastewater treatment facility which comprises a hydrophilic tubular capillary membrane filtration unit for production of a retentate stream and a filtrate stream, and a septic/bio digester in fluid communication with the retentate stream of said tubular capillary membrane filtration unit, a holding tank in fluid communication with the filtrate stream of said tubular capillary membrane filtration unit, a means for transferring processed water from said septic/bio digester to an inlet of said hydrophilic tubular capillary membrane filtration unit, a means for directing filtered water received from said septic/bio digester by said hydrophilic tubular capillary membrane filtration unit to a greenhouse, and a means to return waste water from said greenhouse to said hydrophilic tubular capillary membrane filtration unit.

In an embodiment, the wastewater treatment facility further includes a plurality of solar panels in electrical communication with said treatment facility.

In an embodiment, the wastewater treatment facility further includes at least one rechargeable battery in electrical communication with said plurality of solar panels.

In a further embodiment, the wastewater treatment facility also includes a means for withdrawing a fuel gas from said septic/bio digester.

In another embodiment the wastewater treatment facility additionally may include a shipping container for housing said wastewater treatment facility, thereby providing a self-contained unitary embodiment.

In yet a further embodiment, the wastewater treatment facility includes a sensor for communicating a low level of water in said holding tank, said sensor in communication with a controller for initiating drawing of water from a water source upon receipt a signal indicative of a low level of water in said holding tank.

In addition to the above-described installation, the invention contemplates a process for reusing water from a septic/ bio digester including the steps of:

a) providing a hydrophilic tubular capillary membrane filtration unit for production of a retentate stream and a filtrate stream;

b) providing a septic/bio digester in fluid communication with the retentate stream of said tubular capillary membrane filtration unit;

c) providing a holding tank in fluid communication with the filtrate stream of said tubular capillary membrane filtration unit;

d) providing a means for transferring processed water from said septic/bio digester to an inlet of said hydrophilic tubular capillary membrane filtration unit;

e) providing a means for directing filtered water received from said septic/bio digester by said hydrophilic tubular capillary membrane filtration unit to a greenhouse; and

f) providing a means to return waste water from said greenhouse to said hydrophilic tubular capillary membrane filtration unit;

whereby water from said septic/bio digester is efficiently reused.

The invention will now be described with reference to the figures.

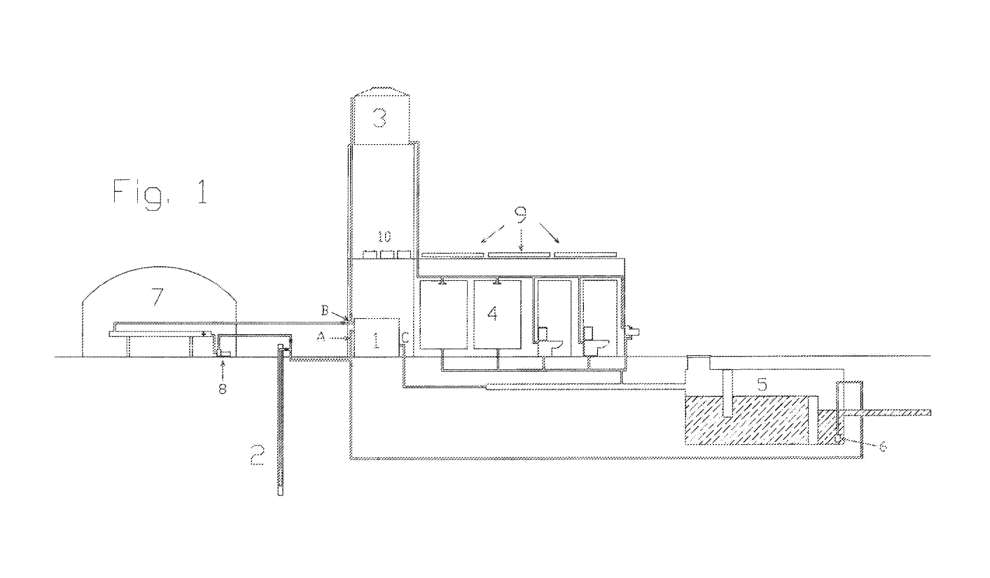

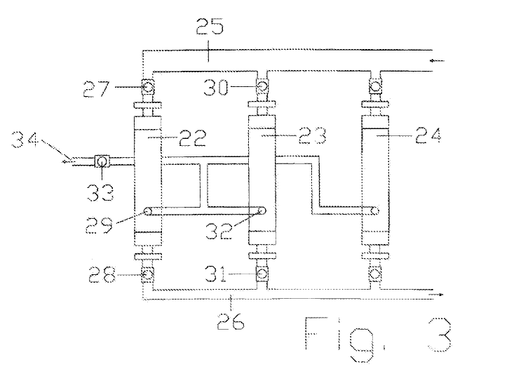

With reference to FIG. 1, a system to reuse water from a septic/bio digester, is disclosed. The initial water could come from a well source 2, or from a fresh water source, such as a river or stream (not shown). The water would then be pumped to a filter unit 1, and enters at point A. The filter unit 1 has a hydrophilic tubular capillary membrane system similar to that disclosed in U.S. Pat. No 8,318,021 B2. A filter unit suitable for use in the present invention is shown in FIG. 3.

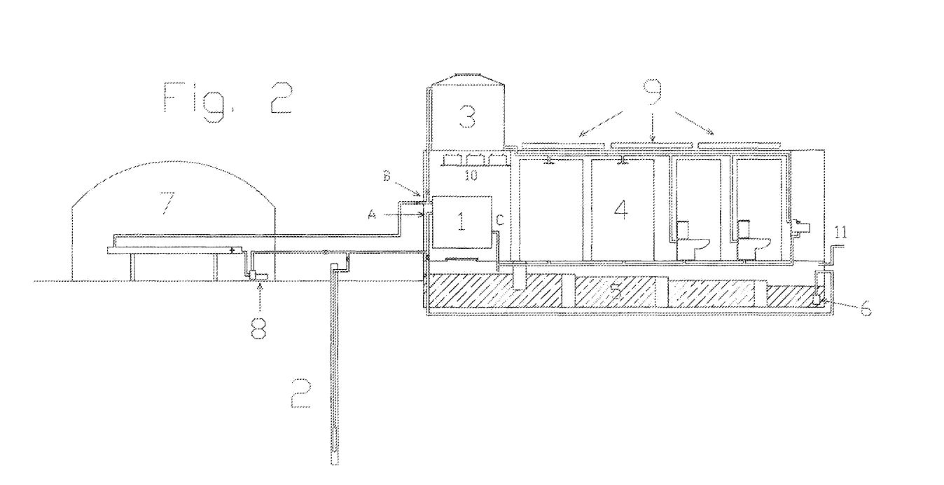

With reference to the filter unit 1 as illustrated by FIG. 3, a diagram of an exemplary, albeit non-limiting filter system is illustrated. While this system is useful in the present invention, it is within the purview of the invention to utilize any similar system. The system uses a first filter 22 and a second filter 23, which are connected in parallel to each other. The filters 22/23 are of the configuration illustrated in FIGS. 1 and 2. The first ends of the filters 22/23 are connected to a supply line 25. The second ends of the filters 22/23 are connected to a drain or containment line 26. Clean water outlet ports 29 and 32 (corresponding to port 18) are connected together and to a clean water outlet line 34. A number of controllable valves are provided. A first set of valves 27/30 selectively connect the fast ends of the filters 22/23 to the supply line 25. A second set of valves 28/31 selectively connect the second ends of the filters 22/23 to the drain or containment line 26. A third valve 33 selectively connects the outlet ports 29 and 32 to the clean water outlet line 34.

In normal operation of the system shown in FIG. 3, valves 27, 30, and 33 would be in the open position, while valves 28 and 31 would be in the closed position. This allows the water from line 25 to flow through the filters 22/23 and out to the clean water outlet 34. In order to back flush the filter 22, valves 27 and 33 would be closed. Valve 28 would be opened. In this mode, water would continue to flow from water supply 25 into filter 23 and out port 32. The water from port 32 would then flow backward into port 29 and through filter 22. The effect of this would be to push the filtered material away from the inside of the capillary membranes of filter 22 and out the drain valve 28 into line 26. After 3 to 30 seconds of operation with respect to back flushing filter 22, the valves would all be returned to normal operation. Next, to back flush filter 23, the procedure as described above would be implemented with respect to filter 23. So, valves 30 and 33 would be closed; and valve 31 would be opened This allows water to flow from water supply 25 into filter 22 and out through port 29, then flow in a backward direction into port 32, through filter 23 and out past valve 31 into drain or containment line 26. After 3 to 30 seconds all valves would return to normal operation positions. It will be noted that the system of FIG. 3 further shows the presence of a third filter 24. This disclosure is made to suggest that the system may implement the placement of numerous filters in parallel connection, and each would be back flushed in the same manner the filters 22/23 with sequential operations.

When multiple filters are present and connected in parallel in the system, these filters will create more than enough flow to not only back flush any one other filter but still provide enough flow for supply outlet 34. Thus, in an enhancement from the process discussed above, there may not be a need during the back flushing operation to shut valve 33.

Now, with further reference to FIG. 1, in the present system, removal of bacteria, virus, proteins, metals, organic materials, particles and molecules is achieved, subsequent to which the contaminants exit via port C, to the septic tank 5. The sterile water would then be pumped out of port B, and up to holding tank 3, where it is stored for usage in the showers, toilets, and sinks in section 4. After the water is used it is drained into septic tank 5, where the processing bacteria digest the sludge, and other waste. Water in the septic tank will gravitate to the opposite end. Residence time in the septic tank will depend upon the type of processing bacteria used to process the water, and the volume of the tank will depend upon how much water is used, and how long it needs to be in the septic process. Pump 6 then pumps the processed septic water back to the filtration unit 1, where any unprocessed bacteria or viruses, (and left over processing bacteria) is removed and sent out C, back to be reprocessed.

This helps with the circulation of the working bacteria, helping recharge the septic system, instead of wasting it by placement in a drain field, or other disposal. The filtered water from the septic system (which only has a small amount of nitrogen, phosphorus and potassium), is then pumped out port B, and is directed by valves to the greenhouse 7. Here the nitrogen, phosphorus, and potassium are removed by plants or low maintenance algae beds, and the water gravitates to pump 8, where a float indicator starts the pump, and sends the water back to the filtration unit 1, port A. The filtration unit then removes any bacteria picked up in the plant beds, and sends the contaminants out of port C to the septic system to be processed, and the clean water out of port B, to holding tank 3. A sensor in tank 3, will let the computer in the filtration unit 1 know when it is low on water, and the computer will draw water from the water source 2, as needed. The whole system can be powered by solar panels 9, with rechargeable batteries 10 so that the system can be energy independent, or can be hooked up to local electrical power.

With reference now to FIG. 2, an embodiment is shown wherein the filtration unit 1, water storage tank 3, showers, toilets, and sinks 4, the septic/bio digester 5, solar panels 9, and batteries 10, are assembled within a shipping container. This container can be sent to a small village or town, and would be self-sustainable, providing drinking water, plant nutrients, and (depending on the bacteria chosen for the bio digester) a source of fuel for cooking and the like, which would exit from line 11, from the bio digester. The greenhouse 7 could be erected nearby to help the community to raise food. The water supply 2 could be from a well, river or stream.

The same system could also be used for fish farming, where the fish water would be slowly circulated into the bio digester, processed and filtered, and sent back to the fish tanks to grow healthy fish. The filtration unit also removes mercury and other contaminants so that the fish are safer to eat.

Liquified waste from animals can also be sent to the bio digester with or without the waste from area 4, thus cleaning up the environment for the animals, and providing them with clean drinking water. Also utilizing a bio digester would create an income from the gas energy produced, and help to recycle the sterile water back to the animals, and the processed water could be used on crops, to benefit from the nitrogen, phosphorus, and potassium.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A wastewater treatment facility comprising:
a hydrophilic tubular capillary membrane filtration unit for production of a retentate stream and a filtrate stream;
a septic/bio digester in fluid communication with the retentate stream of said tubular capillary membrane filtration unit;
a holding tank in fluid communication with the filtrate stream of said tubular capillary membrane filtration unit;
a means for transferring processed water from said septic/bio digester to an inlet of said hydrophilic tubular capillary membrane filtration unit;
a means for directing filtered water received from said septic/bio digester by said hydrophilic tubular capillary membrane filtration unit to a greenhouse; and
a means to return waste water from said greenhouse to said hydrophilic tubular capillary membrane filtration unit.

2. The wastewater treatment facility of claim 1, further comprising:
a plurality of solar panels in electrical communication with said treatment facility.

3. The wastewater treatment facility of claim 2, further comprising:
at least one rechargeable battery in electrical communication with said plurality of solar panels.

4. The wastewater treatment facility of claim 1, further comprising:
a means for withdrawing a fuel gas from said septic/bio digester.

5. The wastewater treatment facility of claim 1, further comprising:
a shipping container for housing said wastewater treatment facility.

6. The wastewater treatment facility of claim 1, further comprising:
a sensor for communicating a low level of water in said holding tank, said sensor in communication with a controller for initiating drawing of water from a water source upon receipt a signal indicative of a low level of water in said holding tank.

7. A process for reusing water from a septic/ bio digester comprising:
providing a hydrophilic tubular capillary membrane filtration unit for production of a retentate stream and a filtrate stream;
providing a septic/bio digester in fluid communication with the retentate stream of said tubular capillary membrane filtration unit;
providing a holding tank in fluid communication with the filtrate stream of said tubular capillary membrane filtration unit;
providing a means for transferring processed water from said septic/bio digester to an inlet of said hydrophilic tubular capillary membrane filtration unit;
providing a means for directing filtered water received from said septic/bio digester by said hydrophilic tubular capillary membrane filtration unit to a greenhouse; and
providing a means to return waste water from said greenhouse to said hydrophilic tubular capillary membrane filtration unit;
whereby water from said septic/bio digester is efficiently reused.
